(19) United States
(12) Patent Application Publication
(10) Pub. No.: US 2011/0247745 A1
(43) Pub. Date: Oct. 13, 2011

(54) METHOD AND DEVICE FOR EQUIPPING CONTAINERS

(75) Inventor: DIETER LEYKAMM, Neutraubling (DE)

(73) Assignee: KRONES AG, Neutraubling (DE)

(21) Appl. No.: 13/168,425

(22) Filed: Jun. 24, 2011

Related U.S. Application Data
(62) Division of application No. 11/231,422, filed on Sep. 21, 2005.

(30) Foreign Application Priority Data
Sep. 30, 2004 (DE) 102004047595.4

(51) Int. Cl. B29C 63/10

(52) U.S. Cl. 156/187

(57) ABSTRACT

Method and device for equipping containers as well as containers with a circumferential label which encloses the container circumference, where the circumferential label, which presents a front edge and a back edge, and which is made of rigid cardboard material, is brought closer with its front edge to the lateral surface of a container, attached to the latter at least temporarily by gluing, then wrapped upon the circumference of the container, and the back edge is attached at least temporarily by gluing to the lateral surface joint on joint with the front edge in a lying position.

### REFERENCE TO RELATED APPLICATION

This is a divisional of U.S. application Ser. No. 11/231,422, filed Sep. 21, 2005, which claims priority to German application no. 102004047595.4, filed Sep. 30, 2004. The entire text of the priority application is incorporated herein by reference in its entirety.

### FIELD OF THE DISCLOSURE

The disclosure relates to a method and a device for equipping containers with a circumferential label, which encloses the container circumference and a container.

### BACKGROUND OF THE DISCLOSURE

From EP 0 059 818 B1 a machine is known for the application of individual protective cutouts on containers, for example, bottles, which comprises at least one pair of cheek plates to wrap a protective cutout around a container, as well as an attachment device for the external ends of the protective cutout which is applied by wrapping. Because of the cheek plates provided, it is also conceivable to use this machine for the processing of protective cutouts made of a relatively rigid material. However, the drawback is the low production rate of this equipping procedure, in which a prefabricated protective cutout has to be first removed from a storage reservoir which is positioned above the bottle conveyor belt and then it is transported by means of a transfer device, viewed in the conveyance direction of the bottle, in front of its lateral area, in such a manner that, when a bottle is introduced into the pair of cheek plates, the protective cutout is placed around and wrapped on the circumference of the bottle. This system is not only complicated from a mechanical point of view, it also requires, for each individual bottle format, appropriate cheek plates which are adapted to the shape, that is, when processing different bottle formats, it is absolutely necessary to exchange the cheek plates.

From U.S. Pat. No. 4,923,557 a labeling machine is known for processing shrinkwrap plastic film. In this construction, the plastic labels are brought closer by means of a rotating vacuum cylinder to the container to be labeled with the label front edge and they are unwound with their full circumference on a concentric unrolling railing, which is concentric with respect to the rotation axis of the vacuum cylinder, resulting in the formation of an overlapping adhering area between the label front end and back edge.

### SUMMARY OF THE DISCLOSURE

The disclosure relates to the problem of providing a method and a device for equipping containers, as well as to containers which can be manufactured thereby, which make it possible to equip with rigid equipment materials at high production rates.

In contrast to the known state of the art, the circumferential labels made of rigid cardboard material are not applied to the middle portion of the lateral surface of a container and then the sections which extend on both sides laterally are placed around the lateral surface, rather a cutout which forms the circumferential label is brought closer tangentially, where the preceding front edge is synchronous with the conveyance speed of a container to be labeled, to the lateral surface of the latter, followed by adhesion, unwinding the entire circumference by rotating the container about its vertical axis, so that the back edge of the cutout is applied joint on joint against the front edge and can also be glued to the lateral surface of the container. This labeling process can be carried out reliably with a very high production rate. To complete the process, the circumferential label which is made of a rigid cardboard material is enclosed over its entire circumference with a label made of a plastic film. This tubular plastic label is applied closely to the circumferential label made of cardboard material, which lies under it, and it applies against the latter an application pressure which is directed radially inward toward the bottle, particularly in the case of a shrinkwrap label.

The expression shrinkwrap label denotes not only mechanically prestressed or pre-expanded labels, which, once the preliminary force has been removed, automatically resume their initial position, but also thermal or chemical shrinkwrap labels, which, after an appropriate shrink treatment are applied closely against the contour of a container. As the result of the tubular envelopment, the circumferential label itself, which is made of cardboard material, can then no longer fall off the bottle, if the adhesion to its label front and/or back edge is only temporary.

In addition, it is advantageous to provide protection against humidity, if the plastic label extends beyond the circumferential label located radially under it, in the axial direction both at the upper and at the lower edge.

For the application of the tubular plastic label, a cutting tool is used to pull off a rectangular cutout from a roll of a plastic band and cut it to an appropriate length. The label front edge is provided with an application of adhesive, which is preferably in the form of a vertical strip of glue (hot glue); the same applies to the label back edge, where a UV hardenable hot glue is particularly well suited because of its high temperature resistance, if a thermal shrink treatment is to be applied later. The plastic label which has been prepared accordingly is then glued with its front edge to the already present circumferential label and the entire circumference is wrapped on with the formation of an overlapping glued section. After a UV treatment of the overlapping glued section for hardening the special UV hot glue, the extending label areas are shrinkwrapped on the contour.

### BRIEF DESCRIPTION OF THE DRAWINGS

A preferred embodiment example is explained below with reference to the figure. In the drawing:

FIG. 1 shows a bottle in a lateral view before and after the labeling, and

FIG. 2 shows a labeling machine for equipping a bottle according to FIG. 1 in a top view.

### DETAILED DESCRIPTION OF THE DISCLOSURE

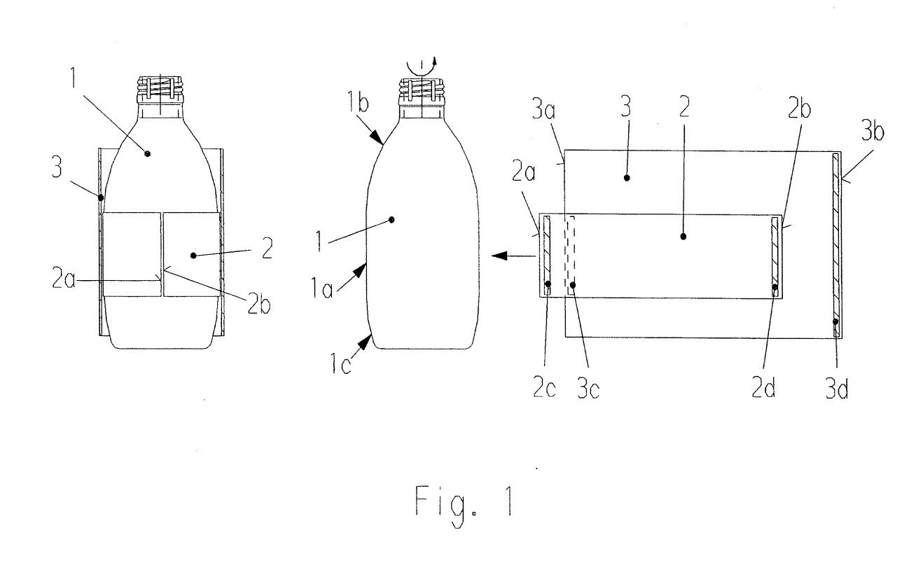

The bottle 1, shown in FIG. 1, which is made of metal, for example, aluminum or a similar metal, glass, plastic or another material, has a cylindrical lateral surface 1a, which transitions above and below into radially inward shaped shoulder and bottom areas 1b, 1c, respectively.

The entire circumference of the cylindrical area 1a is enclosed by a cardboard label 2, whose front and ending edge 2a and 2b, respectively, after they are wrapped on, come in contact, almost without gap, joint on joint (see FIG. 1 left) and are attached with hot glue areas 2c, 2d to the cylindrical bottle wall.

Above this label, a preferably plastic label 3 is directly applied, which covers the cardboard label 2 completely and overextends in the axial direction beyond cardboard label's upper and lower edge and also partially beyond the shoulder and bottom area 1b, 1c, respectively, of the bottle. At the left of FIG. 1, the plastic label 3 is shown in the state where it has already been wrapped on, but is still in the unshrunk state, where only the back half of the plastic label shown in a vertical cross section is depicted. The plastic label 3 in the present case consists of an originally rectangular film cutout (see FIG. 1 right), whose length is greater than the cylindrical lateral circumference of the bottle 1. Accordingly, the back edge 3b extends over the front edge 3a in the wrapped state, and it is attached to the latter with a vertical glue strip 3d made of a UV hardenable hot glue, while the front edge 3a is also attached with hot glue 3c to the outside on the cardboard label 2. After a shrink treatment of at least the overextending upper and lower edges of the plastic label 3, the latter is applied closely to the bottle contour and thus protects the cardboard label 2 from humidity or other damaging influences, such as, for example, scratching due to friction. The cardboard label 2 forms a heat insulation and optionally a stiffening, particularly for extremely thin-walled aluminum bottles. The cardboard label can be can have print on its external side, particularly if the plastic label located above it is at least partially transparent.

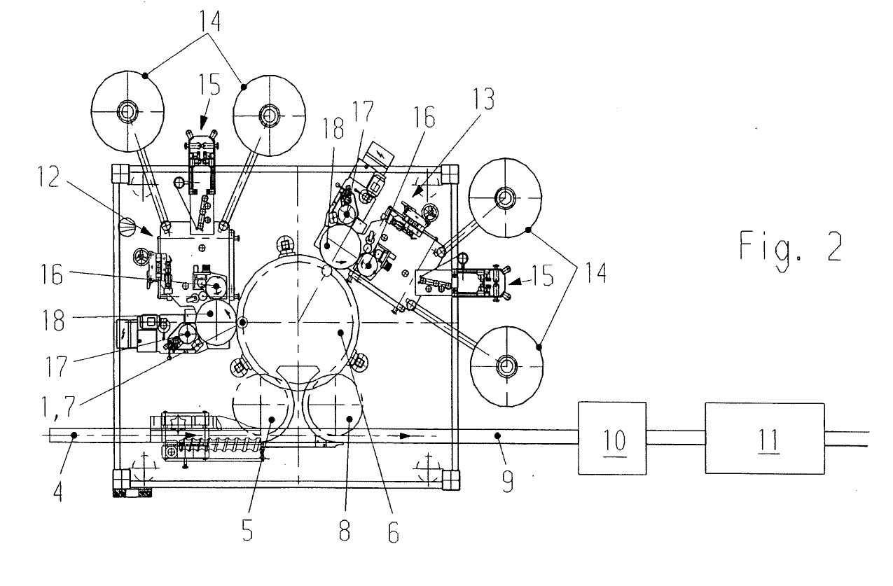

FIG. 2 shows an appropriate labeling machine for equipping bottles with the above described two-layer labeling.

It presents, in a manner which in itself is known, a feed conveyor 4, an infeed star wheel 5 with a single-part screw located in front of it, a carousel 6 with a multitude of rotating plates 7, which are arranged at equal intervals on a section of a circle, an outlet star wheel 8 and an outlet conveyor 9, which leads through a UV tunnel 10 and a shrinkage tunnel 11. The listed transport elements, which move the bottles 1 through the machine, can be driven continuously with speed and position synchronicity with respect to each other.

In the circumferential area between the infeed star wheel 5 and the outlet star wheel 8, on the external periphery of the carousel 6, and with mutual offset in the direction of rotation, a first labeling unit 12 is located for the application of cardboard labels 2 and a second labeling unit 13 is located for the application of plastic labels 3. The structure of the two labeling units is in mutual agreement.

Each one of the labeling units 12, 13 has two label roll uptakes 14, a splicing station 15 located in between, a cutting tool 16, a gluing station 17 and a vacuum cylinder 18 for the transfer of a precut label 2, 3, which has been coated with glue on its front or back edge, to a passing bottle 1.

The processing of labeling a bottle 1 occurs in detail as described below:

The bottle 1, which is delivered by the inlet conveyor 4, is introduced in connection with a laterally arranged single-part screw in the correct position into the infeed star wheel 5, and from there it is shifted in a continuous movement onto a rotating plate 7 of the carousel 6. From there, the bottle 1 is brought closer axially by a liftable and lowerable centering bell—not shown—which is controlled relative to the rotating plate 7, to the rotating plate, to which it is clamped, and as a result of the circumferential movement of the carousel it is brought closer tangentially to the vacuum cylinder 18 of the first labeling unit 12.

Simultaneously, one of the two supply rollers is brought closer by a controlled band unwinding device in collaboration with a sensor which recognizes a printed pattern or a marking, delivers a cardboard band to the cutting tool 16, in such a manner that a rectangular label cutout with a length which corresponds to the cylindrical circumference of the bottle 1 is separated, in the correct position with respect to the printed pattern, and transferred to the vacuum cylinder 18, which then moves the cardboard label 2, with its back side turned outward, past the gluing roller of the glue application station 17. This cardboard label 2 here receives, in the area of its front or back edge 2a, 2b in each case the application of glue, possibly UV hardenable hot glue, which is applied preferably in the form of vertical glue strips 2c, 2d. The passing label edge 2a is then brought closer to the lateral surface of the bottle 1, attached by gluing with the associated glue area 2c, and in the further process it is wound around the entire circumference as a result of the rotation of the bottle 1 about its vertical axis, due to the rotating plate 7, where the front end and back label edges 2a, 2b joint on joint come into position and both are glued to the bottle 1. This process occurs during the continuous rotation of the carousel 6.

The same process which is the same in principle occurs with the second labeling unit 13, while the bottle 1, which now already has a cardboard label 2, is brought closer to the vacuum cylinder 18. However, compared to the cardboard label 2, a plastic label 3 which has been separated from a plastic film roll presents a greater length and height, so that the front end and back edges 3a, 3b of the plastic label 3 overlap after the wrapping on, and the longitudinal margins extend axially beyond the lower as well as the upper margin of the cardboard label 2. The glue application 3c, 3d is carried out as described above, but necessarily with UV hardenable hot glue, at least for the overlapping glued section. To achieve a durable overlapping glued section it is advantageous to support, to the extent possible over the entire surface area, the label margins, which overextend over the top and the bottom during the process of wrapping, on their radially internal side, at least in the overlapping area. This can be achieved using a shaped centering bell.

After passing the second labeling unit 13 and after the completion of the process of application by winding, the bottle 1 reaches the outlet star wheel 8 and it is transferred to the outlet conveyor 9.

The outlet conveyor 9 transports the finished labeled bottles 1 first through the UV tunnel 10, in which an intensive crosslinking and hardening of the hot glue occurs by UV irradiation, even before the thermal application of the plastic label 3 in the shrinkage tunnel 11 starts. By means of this treatment, the hot glue is able to withstand high heat, and bursting of the overlapping glued section during the shrink treatment is reliably prevented.

The shrink treatment can be limited to the label areas which overextend above and below, or it can be applied to the entire surface area. After the plastic label 3 leaves the shrinkage tunnel 11, it is applied closely against the bottle contour.

I claim:

1. Method for equipping containers with a circumferential label which encloses a container circumference, comprising forming a circumferential label of rigid cardboard material to present a front edge and a back edge, bringing the circumferential label closer with its front edge to a lateral surface of a container, attaching the circumferential label to the container at least temporarily by gluing, wrapping the circumferential label upon the circumference of the container, and attaching the back edge at least temporarily by gluing to the lateral surface joint on joint with the front edge in a lying position.

2. Method according to claim 1, and pulling the circumferential label off a cardboard band roll, cutting the circumferential label to an appropriate container circumference length, providing in the area of the front edge and the back edge with an adhesive, and leading the circumferential label to a container.

3. Method according to claim 1, and completely wrapping on the circumferential label, after the front edge has been brought closer and is attached by gluing, as a result of the rotation of the container about its vertical axis.

4. Method according to claim 1, and after the application of the circumferential label made of cardboard material, enclosing the latter label with a shrinkwrap plastic label over the entire circumference.

5. Method according to claim 4, and forming the plastic label as a cutout with a front edge and a back edge, bringing the front edge closer to the container and/or circumferential label, attaching the front edge of the plastic label by gluing and wrapping the cutout with formation of an overlapping connection of the back edge of the plastic label with the front edge of the plastic label upon the container and/or the circumferential label.

6. Method according to claim 5, and subjecting the plastic label, after the application to the container and/or circumferential label, to a shrink treatment.

7. Method according to claim 6, and applying a UV crosslinkable hot glue to the front edge of the plastic label, before wrapping said plastic label onto the container and/or circumferential label.

8. Method according to claim 7, and prior to performing the shrink treatment, and after the plastic label is wrapped onto the container and/or circumferential label, subjecting at least the areas of the plastic label which are provided with UV crosslinkable hot glue to a UV irradiation to crosslink the hot glue.

9. Method according to claim 2, wherein the adhesive is a hot glue.

10. Method according to claim 3, wherein the complete wrapping occurs during a transport of the container.

11. Method according to claim 4, and wherein the upper and lower edges of the shrinkwrap plastic label extend beyond the margins of the circumferential label.

12. Method according to claim 6, wherein the shrink treatment is thermal shrink treatment.

13. Method according to claim 6, and applying a UV crosslinkable hot glue to the back edge of the plastic label before wrapping said plastic label onto the container and/or circumferential label.

14. Method for equipping containers with a circumferential label which consists of a rigid cardboard material and which encloses an external circumference of the container and with a second shrinkwrap plastic label comprising:
application of the circumferential label by a first labeling unit;
application of the shrinkwrap plastic label which covers the circumferential label wherein the upper and lower edges of the shrinkwrap plastic label extend beyond the margins of the circumferential label by a second labeling unit which is arranged behind the first labeling unit in the direction of advance of the container; and
securing the container by a rotating plate such that the container rotates about a vertical axis of the container such that the circumferential label is wound around the entire surface such that the front edge and the back edge are lying in a joint to joint position as the circumferential label is applied by the first labeling unit,
where the rotating plate secures the container such that the container rotates about a vertical axis of the container such that the front and back edges of the plastic label overlap as the plastic label is applied by the second labeling unit, and
wherein in the upward path of the container behind the second labeling unit the plastic label is subjected to a shrink treatment.
